(19) United States
(12) Patent Application Publication
(10) Pub. No.: US 2024/0208865 A1
(43) Pub. Date: Jun. 27, 2024

(54) PIGMENTED SUSPENSION FOR USE IN CONCRETE DENSIFICATION AGENTS

(71) Applicant: Concrete Sealants, Inc., Tipp City, OH (US)

(72) Inventors: Van R. Foster, Tipp City, OH (US); Samuel Lines, Tipp City, OH (US); Jesse Wingert, Tipp City, OH (US)

(21) Appl. No.: 18/085,820

(22) Filed: Dec. 21, 2022

(51) Int. Cl. C04B 20/10; C04B 14/06; C04B 14/30

(52) U.S. Cl. CPC C04B 20/1062; C04B 14/062; C04B 14/308; C04B 20/1048; C04B 20/1051; C04B 2103/50

(57) ABSTRACT

An additive for use with concrete mixtures, comprising a colorant, wherein the colorant further comprises a pigment having a predetermined color, and wherein the inorganic pigment is suspended in a solution that comprises a predetermined percent by weight of water; a predetermined percent by weight of dispersant; and a predetermined percent by weight of defoamer; and a concrete densification agent into which the colorant is mixed, wherein the concrete densification agent further comprises a predetermined percent by weight of water; a predetermined percent by weight of a densifier; a predetermined percent by weight of a water repellant; a predetermined percent by weight of a defoamer; a predetermined percent by weight of urea; a predetermined percent by weight of a freeze-thaw stabilizer; and a predetermined percent by weight of a thickener.

### BACKGROUND

The disclosed technology relates in general to additives and other materials used with concrete mixtures, and more specifically to a pigmented suspension for inclusion in concrete densification agents used in concrete manufacturing systems, methods, and processes.

Cement or concrete densification agents are often used in the preparation of poured concrete structures for improving or enhancing materials properties such as water permeability, compressive strength, dry shrinkage reduction, and alkali-silica reactivity reduction. Controlling these properties is particularly important for maintaining the structural integrity of precast concrete structures such as utility access holes, water containment structures, and concrete pipes where exposure of materials to water is constant. Because the inclusion of concrete densification agents in concrete structures is considered advantageous, color may be added to the agent so that its presence within a final concrete structure can be confirmed. Various colorants or waterborne dyes may be used for this purpose, but tend to fade or become less visible over time. Inorganic pigments such as, for example, iron oxides are suitable materials due to color durability in cured concrete and ability to withstand weather. However, creating a suitable suspension of such pigments for use in coloring concrete densification agents has proven to be technically difficult.

Inorganic pigments are relatively heavy materials that typically require a thickening system for preventing pigmented material from falling out of suspension. While such thickening systems do exist, they often do not yield successful long term results and may actually impede the development of a color when added to a concrete mix. Dispersions of inorganic pigments have been previously developed; however, when added to a concrete mix, color did not fully develop in the slurry or faded over time. The previously known method of packaging inorganic pigments in a water-soluble bag, which dissolves in a cement slurry to provide the desired color, adds complexity and cost to the concrete manufacturing process by requiring storage of the bagged materials in a dry, moisture-free environment prior to use. Accordingly, there is an ongoing need for a cost-effective, functional, and durable pigmented suspension for use with concrete densification agents. Because finished concrete structures are often exposed to potable sources of water, these pigmented suspensions must also be compliant with NSF/ANSI 61: Drinking Water System Components-Health Effects, which is an American National Standard that establishes minimum health-effects requirements for chemical contaminants and impurities that are indirectly imparted to drinking water from products, components, and materials used in drinking water systems.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a first additive for use with concrete mixtures, comprising a pigment having a predetermined color, wherein the pigment is suspended in a solution that comprises a predetermined percent by weight of water; a predetermined percent by weight of dispersant; and a predetermined percent by weight of defoamer. The predetermined percent by weight of water may be in the range of 15-56; the predetermined percent by weight of dispersant may be in the range of 4.0-10.0; and the predetermined percent by weight of defoamer may be in the range of 0.05-0.5. The additive may further comprise a predetermined percent weight of bactericide. The predetermined percent by weight of bactericide may be in the range of 0.01-1.0. The pigment may include an inorganic pigment such as iron oxide, and the color of the iron oxide may be red. The suspension is specifically formulated to be added to a concrete densification agent.

The concrete densification agent may further comprise a predetermined percent by weight of water; a predetermined percent by weight of a densifier; a predetermined percent by weight of a water repellant; a predetermined percent by weight of a defoamer; a predetermined percent by weight of urea; a predetermined percent by weight of a freeze-thaw stabilizer; and a predetermined percent by weight of a thickener. The predetermined percent by weight of water may be in the range of 35.0-75.0; the predetermined percent by weight of densifier may be in the range of 10.0-40.0; the predetermined percent by weight of water repellant may be in the range of 1.0-5.0; the predetermined percent by weight of defoamer may be in the range of 0.05-0.5; the predetermined percent by weight of urea may be in the range of 0.1-5.0; the predetermined percent by weight of freeze-thaw stabilizer may be in the range of 0.1-5.0; and wherein the predetermined percent by weight of thickener may be in the range of 0.50-5.0. The densifier may include colloidal silica. The water repellant may include silane, a siloxane dispersion, or a siloxane emulsion. The freeze-thaw stabilizer may include a glycol. The thickener may include an associative thickener, an inverse thickener, fibers, or a polysaccharide.

Another implementation of the disclosed technology provides a second additive for use with concrete mixtures, comprising a colorant, wherein the colorant further comprises a pigment having a predetermined color, and wherein the pigment is suspended in a solution that comprises a predetermined percent by weight of water; a predetermined percent by weight of dispersant; and a predetermined percent by weight of defoamer; and a concrete densification agent into which the colorant is mixed, wherein the concrete densification agent further comprises a predetermined percent by weight of water; a predetermined percent by weight of a densifier; a predetermined percent by weight of a water repellant; a predetermined percent by weight of a defoamer; a predetermined percent by weight of urea; a predetermined percent by weight of a freeze-thaw stabilizer; and a predetermined percent by weight of a thickener. Regarding the colorant solution, the predetermined percent by weight of water may be in the range of 15-56; the predetermined percent by weight of dispersant may be in the range of 4.0-10.0; and the predetermined percent by weight of defoamer may be in the range of 0.05-0.5. Regarding the concrete densification agent, the predetermined percent by weight of water may be in the range of 35.0-75.0; the predetermined percent by weight of densifier may be in the range of 10.0-40.0; the predetermined percent by weight of water repellant may be in the range of 1.0-5.0; the predetermined percent by weight of defoamer may be in the range of 0.05-0.5; the predetermined percent by weight of urea may be in the range of 0.1-5.0; the predetermined percent by weight of freeze-thaw stabilizer may be in the range of 0.1-5.0; and the predetermined percent by weight of thickener may be in the range of 0.50-5.0.

The additive may further comprise a predetermined percent weight of bactericide. The predetermined percent by weight of bactericide may be in the range of 0.01-1.0. The pigment may include an inorganic pigment such as iron oxide, and the color of the iron oxide may be red. The densifier may include colloidal silica. The water repellant may include silane, a siloxane dispersion, or a siloxane emulsion. The freeze-thaw stabilizer may include a glycol. The glycol may be ethylene glycol, diethylene glycol, or propylene glycol. The thickener may be a non-associative thickener. The thickener may include an associative thickener, an inverse thickener, fibers, or a polysaccharide.

Still another implementation of the disclosed technology provides a third additive for use with concrete mixtures, comprising a colorant, wherein the colorant further comprises a material having a predetermined color, wherein the material includes an inorganic pigment such as red iron oxide, and wherein the material is suspended in a solution that comprises a predetermined percent by weight of water; a predetermined percent by weight of dispersant; a predetermined percent by weight of bactericide; and a predetermined percent by weight of defoamer; and a concrete densification agent into which the colorant is mixed, wherein the concrete densification agent further comprises: a predetermined percent by weight of water; a predetermined percent by weight of a densifier, wherein the densifier includes colloidal silica; a predetermined percent by weight of a water repellant; a predetermined percent by weight of a defoamer; a predetermined percent by weight of urea; a predetermined percent by weight of a freeze-thaw stabilizer; and a predetermined percent by weight of a thickener, wherein the thickener further comprises an associative thickener, an inverse thickener, fibers, or a polysaccharide. Regarding the colorant solution, the predetermined percent by weight of water may be in the range of 15-56; the predetermined percent by weight of dispersant may be in the range of 4.0-10.0; and the predetermined percent by weight of defoamer may be in the range of 0.05-0.5. Regarding the concrete densification agent, the predetermined percent by weight of water may be in the range of 35.0-75.0; the predetermined percent by weight of densifier may be in the range of 10.0-40.0; the predetermined percent by weight of water repellant may be in the range of 1.0-5.0; the predetermined percent by weight of defoamer may be in the range of 0.05-0.5; the predetermined percent by weight of urea may be in the range of 0.1-5.0; the predetermined percent by weight of freeze-thaw stabilizer may be in the range of 0.1-5.0; and the predetermined percent by weight of thickener may be in the range of 0.50-5.0.

The water repellant may include silane, a siloxane dispersion, or a siloxane emulsion. The freeze-thaw stabilizer may include a glycol. The glycol may be ethylene glycol, diethylene glycol, or propylene glycol.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### DETAILED DESCRIPTION

Example implementations are described below. Although the following detailed description contains many specifics for the purposes of illustration, a person of ordinary skill in the art will appreciate that many variations and alterations to the following details are within the scope of the disclosed technology. Accordingly, the following example implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel. Finally, the term “suspension” as used herein refers to dispersions of particles sufficiently large for sedimentation, while dispersions of smaller particles may be referred to as colloids and solutions.

Colloidal silica suspensions may be added to concrete mixtures for the purpose of densifying a concrete mixture. Densifying a concrete mixture reduces the water permeability and increases the compressive strength of cured concrete structures made from such mixtures. As previously discussed, colorants are often added to concrete densification agents to indicate the presence of a concrete densification agent in a concrete mixture used to manufacture a concrete structure. Also as previously discussed, the use of heavy pigments such as iron oxide as markers in concrete densification agents has proven difficult due to technical problems associated with creating stable suspensions using traditional thickening technologies.

The disclosed technology provides: (i) a colored or pigmented suspension for use as a marker in concrete additives (e.g., densification agents) used in concrete manufacturing systems, methods, and processes; and (ii) a colored or pigmented concrete densification agent that includes the colored or pigmented suspension. Example implementations of the disclosed colored suspension include at least one pigmented material, such as by way of non-limiting example, red iron oxide (or other pigmented oxide, such as chromium oxide), or other inorganic pigment or pigments of various colors, combined with a dispersant and a thickening system that allows the iron oxide particles to remain in suspension and retain a desired color after being added to a concrete mixture. The disclosed pigmented suspensions/dispersions do not interfere with the operation or function of the concrete additive in which they are included and may enhance the performance properties of a poured concrete structure such as, for example, by increasing overall compression strength. The disclosed formulations may also be manufactured using materials and ingredients that allow the concrete densification agent to be compliant with NSF/ANSI 61 standards, which are required for the preparation of concrete structures that handle (e.g., store or transport) drinking water.

With reference to TABLE 1, below, various example implementations of a pigmented suspension may be prepared by the following example method:
Step 1: To an appropriate sized container, add deionized water (at a percent by weight in the range of 15-56), defoamer (at a percent by weight in the range of 0.05-0.5) and dispersant (at a percent by weight in the range of 4.0-10.0). The bactericide may be added at this step, if desired (at a percent by weight in the range of 0.01-1.0). Mix these ingredient for 15-30 minutes until a homogeneous mixture is achieved.
Step 2: Slowly add the inorganic pigment, e.g., iron oxide (at a percent by weight in the range of 20.0-75.0), to the container from Step 1 while mixing is still occurring and mix with enough shear to adequately disperse the iron oxide throughout the entire mixture for about 30 minutes until a homogeneous mixture is achieved.
Step 3: If the biocide has not been added in Step 1, the bactericide may be added at this step (at a percent by weight in the range of 0.01-1.0) and mixed until completely solubilized.

TABLE 1, below, lists various example sources for the ingredients included in the example pigmented suspensions.

TABLE 1
Example Pigmented Suspension

| | | | % by |
|---|---|---|---|
| Ingredient | Manufacturer | Category | weight |
| DI Water | Various Commercial | Vehicle | 15- |
| | Sources | | 56 |
| Afcona 2524 | Afcona | Defoamer | 0.05- |
| MD Defoamer | Air Products | | 0.5 |
| Foam-A-Tac 613 | Enterprise Specialties | | |
| KATHON ® LX 1.5% | DOW | Bactericide | 0.01- |
| ACTICIDE ® RS | Thor Specialties | | 1.0 |
| MERGAL ® K-14 | Troy Corporation | | |
| SOLSPERSE ® W100 | Lubrizol Corp. | Dispersant | 4.0- |
| SOLSPERSE ® M430 | Lubrizol Corp. | | 10.0 |
| Iron Oxide | Alabama Pigment, Inc. | Color | 20.0- |
| Iron Oxide | Lanxess, LTD | Pigment | 75.0 |

With reference to TABLE 2 and TABLE 3, below, the disclosed concrete densification agents generally include a densifier; a water repellant; a defoamer; a pigmented marker (i.e., the disclosed colored or pigmented suspension); urea; a freeze-thaw stabilizer; and a thickener. A dispersant and a bactericide are also included in certain example implementations. Dispersants act to reduce overall viscosity and improve fluid flow and inclusion of a bactericide provides acceptable in-can product stability.

The water repellant, which may be, for example, silane, a siloxane dispersion, or a siloxane emulsion, is included to provide water repellency to the surface of a cured concrete structure. The defoamer is included to remove an appropriate amount of entrained air from the concrete mixture, thereby strengthening the concrete when cured. It is important to not remove too much entrained air, otherwise the poured concrete will lack air pores sufficient in number to provide repetitive freeze-thaw stability to the concrete. The freeze-thaw stability of the concrete densification agent can be further enhanced through the use of a glycol, such as for example, ethylene glycol, diethylene glycol, or propylene glycol; or through the use of a glycol combined with urea. Blending glycol and urea was shown to provide effective freeze-thaw stability to the disclosed formulations, which is important because colloidal silica dispersions do not exhibit adequate freeze-thaw stability properties. Once frozen, unprotected colloidal silica becomes destabilized and cannot be reconstituted into a usable state. Use of a glycol/urea combination or other effective freeze-thaw stabilizer provides a stable and usable product, even after freezing has occurred. Incorporation of urea in concrete mixtures not only increases the workability of the concrete mixture but is believed to also increases compressive strength at deep freeze curing temperatures.

Thickeners used with the disclosed formulations may include, by way of non-limiting example, associative thickeners, inverse thickeners, fibers, and polysaccharides that provide acceptable product stability without settling, and that permit the finished product to transfer adequate visible color to a concrete mixture when cured.

Specific example implementations of the disclosed colored concrete densification additive include the pigmented suspension/dispersion described above (5.0-25.0% by weight); a colloidal silica dispersion (10.0-40.0% by weight); deionized water (35.0-75.0% by weight); a water repellent dispersion (1.0-5.0% by weight); defoamer (0.05-0.50), propylene glycol (0.1-5.0% by weight); urea (0.1-5.0% by weight); and an inverse emulsion thickener (0.50-5.0% by weight). Colloidal silica can be stabilized using sodium, lithium, or aluminum ions. TABLE 2 and TABLE 3, which appear below, list various example sources for the ingredients included in the example colored concrete densification additives.

With reference to TABLE 2, below, various example implementations of the disclosed concrete densification agent (with pigment) may be prepared by the following example method:
Step 1: To a mixing vessel, add deionized water (at a percent by weight in the range of 35.0-75.0); and defoamer (at a percent by weight in the range of 0.05-0.50) and mix for 5-10 minutes.
Step 2: With mixing blade running, add colloidal silica (at a percent by weight in the range of 10.0-40.0), water repellant (at a percent by weight in the range of 1.0-5.0); and bactericide (at a percent by weight in the range of 0.01-1.0). Mix for 10-15 minutes.
Step 3: Add the pigmented suspension (at a percent by weight in the range of 5.0-25.0), the freeze-thaw stabilizer (at a percent by weight in the range of 0.1-5.0); and urea (at a percent by weight in the range of 0.1-5.0). (Note: The urea can be premixed in deionized water in a separate container to facilitate addition into the batch.) Step 4: Add thickener (at a percent by weight in the range of 0.50-5.0) and mix for about 30 minutes.

TABLE 2, below, lists various example sources for the ingredients included in the example pigmented suspensions and provides an acceptable percent by weight range for each ingredient.

TABLE 2
Example Concrete Densification Additives (with Pigment)

| | | | % by |
|---|---|---|---|
| Ingredient | Manufacturer | Category | weight |
| DI Water | Various Commercial | Vehicle | 35.0-75.0 |
| | Sources | | |
| LEVASIL ® CS-8 | Nouryon Chemicals | Colloidal | 10.0-40.0 |
| LEVASIL ® CB-25A | | Silica | |
| LEVASIL ® CC-301 | | (Densifier) | |
| PROTECTOSIL ® 600 | Evonik | Siloxane | 1.0-5.0 |
| PROTECTOSIL ® 602 | Wacker | emulsion | |
| PROTECTOSIL ® 700 | | (Water | |
| SILRES ® BS-3004 | | Repellant) | |
| SILRES ® BS-4004 | | | |
| Afcona 2524 | Afcona | Defoamer | 0.05-0.5 |
| MD Defoamer | Air Products | | 0.05-0.5 |
| Foam-A-Tac 613 | Enterprise | | 0.05-0.5 |
| | Specialties | | |
| Color Suspension | Local Preparation | Pigmented | 5.0-25.0 |
| | | Marker | |
| Urea | Various Commercial | Urea | 0.1-5.0 |
| | Sources | | |
| Glycol Ether | Various Commercial | Freeze-Thaw | 0.1-5.0 |
| | Sources | Stabilizer | |
| TEXIPOL ® 63-201 | Scott-Bader | Thickener | 0.50-5.0 |
| TEXIPOL ® 63-508 | | | |
| TEXIPOL ® 63-510 | | | |

TABLE 3, below, lists various example sources for the ingredients included in a specific example pigmented suspensions and provides an acceptable percent by weight for each ingredient.

TABLE 3
Example Concrete Densification Additive (with Pigment)

| | | | % by |
|---|---|---|---|
| Ingredient | Manufacturer | Category | weight |
| Deionized Water | Various Commercial | Vehicle | 62.49 |
| | Sources | | |
| Foam-A-Tac 613 | Enterprise | Defoamer | 0.02 |
| | Specialties | | |
| ACTICIDE ® RS | Thor Specialties | Bactericide | 0.02 |
| LEVASIL ® | Nouryon Chemicals | Colloidal Silica | 21.04 |
| CB25-A | | (Densifier) | |
| PROTECTOSIL ® | Evonik | Siloxane Emulsion | 1.33 |
| W-602 | | (Water Repellant) | |
| Red Iron Oxide | Lanxess, LTD | Pigmented Marker | 11.60 |
| Suspension* | | | |
| TEXIPOL ® | Scott-Bader | Thickener | 1.00 |
| 63-510 | | | |
| Propylene Glycol | Various Commercial | Freeze-Thaw | 1.00 |
| | Sources | Stabilizer | |
| Urea | Various Commercial | Urea | 1.50 |
| | Sources | | |

*Red Iron Oxide Suspension: 3.48% DI Water; 0.89% SOLSPERSE ® W-100; 0.02% Foam-a-Tac 613; 0.01% ACTICIDE ® RS; and 7.20% Red Iron Oxide.

TABLE 4, below, includes results from various experiments wherein concrete samples prepared using the disclosed concrete densification additives (which also included the disclosed pigmented suspension) were tested against a reference standard that did not include a colored concrete densification additive. Differences in compression strength, shrinkage, alkali silica expansion, and rate of water absorption are listed in the Table. Concrete samples prepared using the disclosed pigmented concrete densification additives are known to be compliant with NSF/ANSI 61 based on the specific ingredients and weight percentages used.

TABLE 4
Experimental Results

| Test | | | | | |
|---|---|---|---|---|---|
| Specification | Description | | Reference | Densified | Change |
| ASTM C39 | Compression | | | | |
| | Strength (psi) | | | | |
| | 24 | hours | 1910 | 2390 | +25% |
| | 90 | days | 4322 | 4885 | +13% |
| | 365 | days | 4952 | 5523 | +12% |
| ASTM C157 | Shrinkage (%) | | | | |
| | 56 | days | −0.043 | −0.013 | −70% |
| | 84 | days | −0.053 | −0.022 | −58% |
| ASTM 1260 | Alkali Silica | | | | |
| | Expansion (%) | | | | |
| | 28 | days | 0.229 | 0.188 | −18% |
| ASTM | Rate of Water | | | | |
| C1585 | Absorption | | | | |
| | 90 | days | 5.95 | 3.82 | −36% |

| | | | | |
|---|---|---|---|---|
| CRD-C48 | Concrete Permeability | 3.265 × | 1.3 × | 96% |
| | (K-Value) | 10⁻¹² | 10⁻¹³ | reduction |

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to +5%, such as less than or equal to +2%, such as less than or equal to +1%, such as less than or equal to +0.5%, such as less than or equal to ±0.2%, such as less than or equal to +0.1%, such as less than or equal to +0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. An additive for use with concrete mixtures, comprising:
(a) a pigment having a predetermined color,
(b) wherein the pigment is suspended in a suspension that comprises:
(i) a predetermined percent by weight of water;
(ii) a predetermined percent by weight of dispersant; and
(iii) a predetermined percent by weight of defoamer,
(c) wherein the suspension is formulated to be added to a concrete densification agent.

2. The additive of claim 1, wherein the predetermined percent by weight of water is in the range of 15-56; wherein the predetermined percent by weight of dispersant is in the range of 4.0-10.0; and wherein the predetermined percent by weight of defoamer is in the range of 0.05-0.5.

3. The additive of claim 1, further comprising a predetermined percent weight of bactericide, wherein the predetermined percent by weight of bactericide is in the range of 0.01-1.0.

4. The additive of claim 1, wherein the pigment is an inorganic pigment, wherein the inorganic pigment is selected from the group consisting of iron oxides, and wherein the predetermined color is red.

5. The additive of claim 1, wherein the concrete densification agent further comprises:
(a) a predetermined percent by weight of water;
(b) a predetermined percent by weight of a densifier;
(c) a predetermined percent by weight of a water repellant;
(d) a predetermined percent by weight of a defoamer;
(e) a predetermined percent by weight of urea;
(f) a predetermined percent by weight of a freeze-thaw stabilizer; and
(g) a predetermined percent by weight of a thickener.

6. The additive of claim 5, wherein the predetermined percent by weight of water is in the range of 35.0-75.0; wherein the predetermined percent by weight of densifier is in the range of 10.0-40.0; wherein the predetermined percent by weight of water repellant is in the range of 1.0-5.0; wherein the predetermined percent by weight of defoamer is in the range of 0.05-0.5; wherein the predetermined percent by weight of urea is in the range of 0.1-5.0; wherein the predetermined percent by weight of freeze-thaw stabilizer is in the range of 0.1-5.0; and wherein the predetermined percent by weight of thickener is in the range of 0.50-5.0.

7. The additive of claim 5, wherein the densifier includes colloidal silica.

8. The additive of claim 5, wherein the water repellant includes silane, a siloxane dispersion, or a siloxane emulsion.

9. The additive of claim 5, wherein the freeze-thaw stabilizer includes a glycol.

10. The additive of claim 5, wherein the thickener further comprises an associative thickener, an inverse thickener, fibers, or a polysaccharide.

11. An additive for use with concrete mixtures, comprising:
(a) a colorant, wherein the colorant further comprises a pigment having a predetermined color, and wherein the pigment is suspended in a solution that comprises:
(i) a predetermined percent by weight of water;
(ii) a predetermined percent by weight of dispersant; and
(iii) a predetermined percent by weight of defoamer; and
(b) a concrete densification agent into which the colorant is mixed, wherein the concrete densification agent further comprises:
(i) a predetermined percent by weight of water;
(ii) a predetermined percent by weight of a densifier;
(iii) a predetermined percent by weight of a water repellant;
(iv) a predetermined percent by weight of a defoamer;
(v) a predetermined percent by weight of urea;
(vi) a predetermined percent by weight of a freeze-thaw stabilizer; and
(vii) a predetermined percent by weight of a thickener.

12. The additive of claim 11,
(a) wherein the predetermined percent by weight of water in the colorant is in the range of 15-56; wherein the predetermined percent by weight of dispersant in the colorant is in the range of 4.0-10.0; and wherein the predetermined percent by weight of defoamer in the colorant is in the range of 0.05-0.5; and
(b) wherein the predetermined percent by weight of water in the concrete densification agent is in the range of 35.0-75.0; wherein the predetermined percent by weight of densifier in the concrete densification agent is in the range of 10.0-40.0; wherein the predetermined percent by weight of water repellant in the concrete densification agent is in the range of 1.0-5.0; wherein the predetermined percent by weight of defoamer in the concrete densification agent is in the range of 0.05-0.5; wherein the predetermined percent by weight of urea in the concrete densification agent is in the range of 0.1-5.0; wherein the predetermined percent by weight of freeze-thaw stabilizer in the concrete densification agent is in the range of 0.1-5.0; and wherein the predetermined percent by weight of thickener in the concrete densification agent is in the range of 0.50-5.0.

13. The additive of claim 11, further comprising a predetermined percent weight of bactericide, wherein the predetermined percent by weight of bactericide is in the range of 0.01-1.0.

14. The additive of claim 11, wherein the pigment is an inorganic pigment, wherein the inorganic pigment is selected from the group consisting of iron oxides, and wherein the predetermined color is red.

15. The additive of claim 11, wherein the densifier includes colloidal silica; and wherein the water repellant includes silane, a siloxane dispersion, or a siloxane emulsion.

16. The additive of claim 11, wherein the freeze-thaw stabilizer includes a glycol, and wherein the glycol is ethylene glycol, diethylene glycol, or propylene glycol.

17. The additive of claim 11, wherein the thickener further comprises an associative thickener, an inverse thickener, fibers, or a polysaccharide.

18. An additive for use with concrete mixtures, comprising:
(a) a colorant, wherein the colorant further comprises a material having a predetermined color, wherein the material includes red iron oxide, and wherein the material is suspended in a solution that comprises:
(i) a predetermined percent by weight of water;
(ii) a predetermined percent by weight of dispersant;
(ii) a predetermined percent by weight of bactericide; and
(iv) a predetermined percent by weight of defoamer; and
(b) a concrete densification agent into which the colorant is mixed, wherein the concrete densification agent further comprises:
(i) a predetermined percent by weight of water;
(ii) a predetermined percent by weight of a densifier, wherein the densifier includes colloidal silica;
(iii) a predetermined percent by weight of a water repellant;
(iv) a predetermined percent by weight of a defoamer;
(v) a predetermined percent by weight of urea;
(vi) a predetermined percent by weight of a freeze-thaw stabilizer; and
(vii) a predetermined percent by weight of a thickener, wherein the thickener further comprises an associative thickener, an inverse thickener, fibers, or a polysaccharide.

19. The additive of claim 18,
(a) wherein the predetermined percent by weight of water in the colorant is in the range of 15-56; wherein the predetermined percent by weight of dispersant in the colorant is in the range of 4.0-10.0; and wherein the predetermined percent by weight of defoamer in the colorant is in the range of 0.05-0.5; and
(b) wherein the predetermined percent by weight of water in the concrete densification agent is in the range of 35.0-75.0; wherein the predetermined percent by weight of densifier in the concrete densification agent is in the range of 10.0-40.0; wherein the predetermined percent by weight of water repellant in the concrete densification agent is in the range of 1.0-5.0; wherein the predetermined percent by weight of defoamer in the concrete densification agent is in the range of 0.05-0.5; wherein the predetermined percent by weight of urea in the concrete densification agent is in the range of 0.1-5.0; wherein the predetermined percent by weight of freeze-thaw stabilizer in the concrete densification agent is in the range of 0.1-5.0; and wherein the predetermined percent by weight of thickener in the concrete densification agent is in the range of 0.50-5.0.

20. The additive of claim 18, where in the water repellant includes silane, a siloxane dispersion, or a siloxane emulsion; wherein the freeze-thaw stabilizer includes a glycol, and wherein the glycol is ethylene glycol, diethylene glycol, or propylene glycol.
